(19) United States
(12) Patent Application Publication
(10) Pub. No.: US 2023/0091085 A1
(43) Pub. Date: Mar. 23, 2023

(54) POSITIONING DEVICE, STACKING DEVICE AND STACKING METHOD FOR REPEATING COMPONENTS OF A CELL STACK FOR BATTERY OR FUEL CELLS

(71) Applicant: GROB-WERKE GmbH & Co. KG, MINDELHEIM (DE)

(72) Inventors: Tobias BIBERACHER, MÜNSTERHAUSEN (DE); Joachim STOLZ, KAMMLACH (DE); Michael RATHGEB, AUGSBURG (DE); Tim JANUSCH, ERKHEIM (DE)

(21) Appl. No.: 17/944,247

(22) Filed: Sep. 14, 2022

(30) Foreign Application Priority Data
Sep. 17, 2021 (EP) 21197541.2

(51) Int. Cl. H01M 10/04

(52) U.S. Cl. CPC H01M 10/0404

(57) ABSTRACT

Devices and methods to be used in large-scale production of battery cells or fuel cells when forming cell stacks, including a positioning device for positioning the repeating components of the cell stack. The positioning device includes at least one vibrating jaw having a vibrating jaw contact surface, and a positioning jaw which is rigid in operation and is arranged lower than an upper region of the vibrating jaw and has a positioning jaw contact surface. In one embodiment, the jaws engage each other by complementary protrusion-recess features on the contact surfaces. Alternatively or additionally, the vibrating jaw is provided to move along an arcuate path during oscillation, a tangent of the arcuate path lying on the positioning jaw contact surface.

### CROSS-REFERENCES TO RELATED APPLICATIONS

This application claims the benefit of the European patent application No. 21197541.2 filed on Sep. 17, 2021, the entire disclosures of which are incorporated herein by way of reference.

### FIELD OF THE INVENTION

The invention relates to a positioning device for positioning repeating components of a cell stack for battery or fuel cells to be placed on top of each other. Further, the invention relates to a stacking device for forming a cell stack for a battery cell or fuel cell from repeating components to be placed one on top of the other, comprising at least one such positioning device. Finally, the invention relates to a stacking method using such a stacking device.

For clarification of terms and technological background, reference is made to the following literature/documents:

[1] Wikipedia Accumulator

[2] Wikipedia fuel cell

[3] Unpublished EP patent application EP21159734.9

[4] Unpublished DE application DE 10 2020 133 413.3

[5] WO 2020 216758 A1

[6] DE 38 14 413 A1

[7] DE 41 30 332 A1

[8] DE 10 2005 044 706 A1

[9] DE 27 23 162 A1

[10] DE 10 2016 213 149 A1

[11] EP 0 327 208 A2

[12] EP 0 561 069 A1

[13] EP 1 689 015 A1

[14] WO 2015 065082 A1

From documents [6] to [9], devices and methods are known from paper technology for handling sheets of paper in a paper stack.

In contrast, the present invention is in the fields of manufacturing battery cell stacks (preferably of the type: lithium-ion cell), see [1], and manufacturing fuel cell stacks (preferably of the type: PEMFC), see [2]. Preferred embodiments of the invention relate to a system for receiving, positioning and fixing all components required for the assembly or production of battery cells, such as lithium-ion battery cells, or fuel cell stacks, such as PEMFC stacks, with a view to manufacturing in a large-scale production facility.

Previously known devices and methods for stacking repeating components of battery cells or fuel cells are described in documents [5] and [10] to [14]. In particular, it is known from [5] to position repeating components by means of vibration.

### SUMMARY OF THE INVENTION

The invention is based on the problem of providing a positioning device with which repeating components of battery or fuel cells can be positioned more reliably and precisely when placed in a stack at a fast process speed in large series.

According to a first aspect thereof, the invention provides a positioning device for positioning repeating components of a cell stack for battery or fuel cells to be placed one on top of the other, comprising a vibrating jaw which can be vibrated by means of at least one vibration generator and has a vibrating jaw contact surface for contacting an edge of the repeating component to be placed in order to center it in a vibrating manner, and a positioning jaw which is rigid in operation and is arranged below an upper region of the vibrating jaw and has a positioning jaw contact surface for contacting an edge of the cell stack to be formed in order to hold it in position, wherein

a) the positioning jaw and the vibrating jaw have a complementary protrusion-recess feature at a jaw region forming the contact surfaces, by which protrusion-recess feature the positioning jaw and the vibrating jaw engage each other, and/or

b) the vibrating jaw is adapted to move an end region of the vibrating jaw contact surface disposed near the positioning jaw contact surface along an arcuate path during oscillation, a tangent of the arcuate path lying on the positioning jaw contact surface.

It is preferred that the protrusion-recess feature is a comb structure with grooves formed between teeth, wherein vibrating jaw teeth engage positioning jaw grooves and positioning jaw teeth engage vibrating jaw grooves, the contact surfaces being formed at least partially on the teeth.

In particular, in the embodiment according to alternative b), the protrusion-recess feature may also include a single protrusion on one of the jaws—positioning jaw and vibrating jaw—that engages a recess on the other of the jaws—positioning jaw and vibrating jaw. For example, a positioning jaw tooth may engage a vibrating jaw groove. There may also be a tooth on the vibrating jaw and a tooth on the positioning jaw, and a complementary groove on the vibrating jaw and a complementary groove on the positioning jaw.

It is preferred that the protrusion-recess feature extends over the entire width of the contact surfaces.

It is preferred that a first arrangement of a first positioning jaw and a first vibrating jaw and a second arrangement of a second positioning jaw and a second vibrating jaw oppose each other at a first pair of opposite sides of a receptacle for the cell stack.

It is preferred that a third arrangement of a third positioning jaw and a third vibrating jaw and a fourth arrangement of a fourth positioning jaw and a fourth vibrating jaw oppose each other at a second pair of opposite sides of a receptacle for the cell stack.

It is preferred that the vibration generators of different arrangements can be individually and/or differently actuated. Preferably, the movement in pairs may be in opposite directions or in the same direction or individually inactive. Accordingly, it is preferred that a controller is designed to control the vibration generators in such a way that the movement of the vibration generators in pairs is in opposite directions or the movement of the vibration generators in pairs is in the same direction or that individual vibration generators are inactive.

It is preferred that the vibrating jaw is U-shaped in cross-section with a first leg on which the vibrating jaw contact surface and the protrusion-recess feature are formed, and a second leg which is connected to the vibration generator and has a web which overlaps a body of the positioning jaw.

Preferably, the second leg also has a protrusion-recess feature.

It is preferred that the positioning jaw is chamfered or rounded at an upper end region above the positioning jaw contact surface to form an insertion slope.

It is preferred that the positioning jaw is rounded at an upper end region of the positioning jaw contact surface correspondingly flush or aligned with the arcuate path.

It is preferred that the positioning jaw is block-shaped or strip-shaped.

It is preferred that the positioning jaw is formed such that the protrusion-recess feature is formed on a side surface facing a receptacle for receiving the cell stack.

It is preferred that the positioning jaw extends along a height direction for guiding the edges of the repeating components in the cell stack during height tracking in the receptacle.

It is preferred that the vibrating jaw oscillates between a first end position, in which the vibrating jaw contact surface and the positioning jaw contact surface are aligned with each other, and a second end position, in which the vibrating jaw contact surface is further away from a receptacle for the cell stack than the positioning jaw contact surface, at least in regions.

It is preferred that the vibrating jaw is movably mounted between two end positions on a bearing comprising a preloading element and at least one preferably adjustable stopper.

It is preferred that the vibrating jaw can be connected to the vibration generator or optionally to several vibration generators at optionally variable connection points in order to adjust natural frequencies.

It is preferred that the vibrating jaw can linearly oscillate back and forth perpendicular to the vibrating jaw contact surface.

It is preferred that the vibrating jaw oscillates about an axis oriented horizontally and parallel to the vibrating jaw contact surface.

It is preferred that the vibrating jaw turns back and forth when oscillating about an axis aligned horizontally and parallel to the vibrating jaw contact surface.

As noted above, it is preferred that the vibrating jaws move in pairs in opposite directions, in the same direction, or are individually inactive.

According to a further aspect, the invention provides a stacking device for forming a cell stack for a battery cell or fuel cell from repeating components to be placed one on top of the other, comprising at least one positioning device according to one of the preceding designs and a receptacle having a supporting device movable in the height direction for supporting and adjusting the height of the cell stack during stacking.

According to a further aspect, the invention provides a stacking method for forming a cell stack for a battery cell or fuel cell from a plurality of repeating components to be placed one on top of the other comprising

a) providing a stacking device according to the above-described design,

b) depositing a repeating component,

c) centering the repeating component by vibrating the vibrating jaw to bring it into contact with the positioning jaw contact surface,

e) repeating steps a) to c) with further repeating components to form the cell stack.

Preferably, the stacking process includes the step to be performed after step c):

d) moving the supporting device downwardly,

wherein steps a) to d) are repeated with the further repeating components in step e).

Some advantages and further possible features of preferred embodiments of the invention will be explained in more detail below.

One preferred embodiment of the invention relates to a positioning device for a device for stacking cell components or (laminated or glued) cell stacks. Also described is a stacking device provided with such a positioning device.

The use of vibration for the alignment of components both in the production of lithium-ion battery cells and for the production of fuel cell stacks (PEMFC stacks) has already been described in document [5] (Device for Stacking Laminated or Glued Cell Stacks).

A stacking device according to a preferred embodiment of the invention preferably serves to receive, position and fix all components of a lithium-ion battery cell stack or a fuel cell stack (type: PEMFC stack) during the manufacturing process.

When manufacturing a fuel stack, for example, one focus is on the alternating insertion of the repeating component/s monocell or BPP and MEA, as this takes up the main part of the overall stacking process. Further, there is usually also an upstream or downstream insertion of possible edge components to complete the stacks to the outside; this step is known from the literature and is therefore not considered in detail here. The insertion of the edge components can be done as described in [3] and [4].

In prior art according to the published citations, the pickup and positioning of the alternating repeating component/s monocell or BPP and MEA is done either by rigidly mounted, immovable guide elements or alternatively by positioning jaws that are set in oscillation/vibration in the horizontal plane, orthogonal to the stacking direction in the vertical direction. The generation of the vibration in this case often takes place by a vibration motor.

In known devices, automatic handling systems with pick-and-place applications, e.g., with vacuum grippers, for positioning the repeating component/s monocell or BPP and MEA, as well as workpiece carriers with integrated hold-down devices that fix the repeating component/s in position after dropping, can also be used to produce the cell stacks, and the position can be checked using image processing if necessary.

In embodiments of the invention, positioning is performed by means of vibration of vibrating jaws in conjunction with positioning jaws stationary in the process. This makes it possible to align the individual components precisely and in a way that is easy to handle in terms of process technology.

Due to the continuously increasing demand for battery cells and fuel cells and the required number of individual cells to generate the corresponding electrical power, large numbers of individual components are required that must be stacked precisely and at high process speed to form lithium-ion battery cell stacks or PEMFC stacks. In order to guarantee not only electrical performance but also operational reliability, increasingly precise position tolerances must be maintained during the assembly of the stacks with ever decreasing cycle times, and the protection of the individual components must be ensured.

In tests on the alignment of bonded or laminated battery cell stacks, it was found, among other things, that alignment with an erected separator is not possible without permanent damage to the separator, but that alignment of the individual cell stack layers at the separator edge is possible because the cell stacks have a certain inherent rigidity due to the lamination or bonding of the individual electrode and separator layers. However, the inherent stiffness of the protruding separator is not sufficient for alignment of a stack of many cell stacks, since only the uppermost cell stack layer/s can be centered and the static friction of the individual layers to each other is too large.

Preferred embodiments of the invention enable the production of a stack which meets the high requirements for positional accuracy of the individual layers by depositing individual glued or laminated cell stacks or repeating components one on top of the other as accurately as possible. In preferred embodiments of the invention, the high accuracy is already achieved when the individual cell stacks are positioned one on top of the other, so that an alignment after stack formation of the complete cell stack is no longer necessary.

In particularly preferred embodiments of the invention, a simple adjustment of the dynamic behavior of the vibrating components (vibrating jaw) can also bring about a higher positional accuracy and, consequently, a higher power density of the cell stack, particularly with regard to a format change. This is preferably achieved by independent vibration generation in the longitudinal and transverse directions in the horizontal plane. Depending on requirements, it is possible by means of an individual actuator to optionally operate the vibrations in the longitudinal or transverse direction with different oscillation frequencies. Thus, there is also the possibility of a partial or complete “inactive” operation of the stacking device.

In preferred embodiments of a stacking device according to embodiments of the invention, a positioning device of the stacking device is constructed from several parts. In an upper movable part of the positioning device, the repeating component/s monocell or BPP and MEA are centered by vibration and simultaneous lowering movement into laterally mounted positioning jaws. Vibration jaws acting as centering jaws are designed in such a way that they align the repeating component/s transversely to the lowering movement at the outermost circumferential edge of the repeating component/s, as in the case of the monocell of the separator edge.

Through the continuous lowering movement of the repeating component/s monocell or BPP and MEA, the transfer of the repeating component/s to the lower rigid part of the positioning device to a receptacle with stationary positioning jaws acting as receiving jaws takes place without loss of positioning accuracy, since the vibrating jaws of the upper part acting as centering jaws and the positioning jaws of the lower part acting as receiving jaws engage in each other in a comb-like manner.

In an alternative embodiment of the positioning device and the stacking device provided therewith, the transfer from the movable to the rigid part of the positioning device can also take place by a tangential transfer, upon movement of the vibrating jaws along an arcuate path, e.g., a rotational movement.

An advantage of a positioning device according to preferred embodiments of the invention is that the repeating component/s is/are stacked in a higher positional accuracy to form a cell stack and only the top layer/s of the cell stack is/are aligned, whereby the risk of damage to the repeating component/s and also a loss of position can be reduced. In addition, higher process speeds can be realized by this stacking method, as all processes can run continuously, making the method also applicable for batch production.

Furthermore, the flexible design of the vibration range allows the dynamic behavior of the positioning unit to be easily adapted, in particular by using structure-borne sound transducers to generate vibrations. As a result of this and the simple and compact design of the positioning unit, it can be easily and quickly scaled to other format sizes.

### BRIEF DESCRIPTION OF THE DRAWINGS

Embodiments of the invention will be described in more detail below with reference to the accompanying drawings.

FIG. 1 is a perspective view of a first embodiment of a stacking device for stacking a cell stack of repeating components, with a first embodiment of a positioning device for positioning the repeating components, together with a part of the cell stack in the stacking device;

FIG. 2 is a view of the stacking device according to the first embodiment as in FIG. 1, but without cell stack;

FIG. 3 is a view of the stacking device as in FIG. 1, but with vibration units of the positioning device omitted;

FIG. 4 is an enlarged detailed view of a corner area of the stacking device of FIG. 1;

FIG. 5 is a view as in FIG. 4, but without the cell stack;

FIG. 6 is a section through the vibration unit on one side of the positioning device;

FIG. 7 is a side view of a part of the stacking device of FIG. 1;

FIG. 8 is a view of detail A of FIG. 7;

FIG. 9a-d are views as in FIG. 7 at successive times when inserting a repeating component;

FIG. 10 is a perspective view of the upper region of a second embodiment of a stacking device for stacking a cell stack of repeating components, with a second embodiment of a positioning device for positioning the repeating components, together with a part of the cell stack in the stacking device;

FIG. 11 is a perspective view of a lower region of the stacking device according to the second embodiment;

FIG. 12 is a perspective view of the stacking device in which the upper region and the lower region are assembled;

FIG. 13 is a perspective view of one of several vibration units of the positioning device according to the second embodiment;

FIG. 14 is a side view of the vibration unit of FIG. 13;

FIG. 15 is a top view of the vibration unit of FIG. 13;

FIG. 16 is a sectional view along line C-C of FIG. 15;

FIG. 17 is a perspective view of a corner region of the stacking device of FIG. 12;

FIG. 18 is a side view of an arrangement of a vibrating jaw and a positioning jaw at the corner area of FIG. 17 while positioning a repeating component; and

FIG. 19 is an enlarged view of detail B of FIG. 18.

### DETAILED DESCRIPTION OF THE PREFERRED EMBODIMENTS

Different embodiments of a stacking device 10 for forming a cell stack 12 for a battery cell or fuel cell from a plurality of repeating components 14, 16 to be placed one on top of the other will be described in more detail below with reference to the illustration in the drawings.

The stacking device 10 comprises a receptacle 18 for receiving the cell stack 12 and a positioning device 20 for positioning the repeating components 14, 16 of the cell stack 12 for battery cells or fuel cells to be placed on top of each other.

The receptacle 18 includes a supporting device 22 for supporting the stack of cells 12 during stacking. The supporting device 22 may be stationary in some embodiments not shown in detail herein. Preferably, the supporting device is movable in the height direction to adjust the height of the stack of cells 12 during stacking.

The positioning device 20 comprises at least one movable unit and one stationary unit.

Specifically, the positioning device 20 has, as a movable unit, at least one vibrating jaw 26, 26a, 26a1, 26a2, 26b, 26b1, 26b2, 26c, 26d which can be set in vibration by means of at least one vibration generator 24 and has a vibrating jaw contact surface 28 for contacting an edge of the repeating component 14, 16 to be placed in order to center it in a vibrating manner, and, as a stationary unit, at least one positioning jaw 32, 32a, 32a1, 32a2, 26b, 26b1, 26b2, 26c, 26d which is rigid in operation and is disposed below an upper region 30 of the vibrating jaw 26, 26a1, 26a2, 26b1, 26b2, 26c, 26d, 32a2, 32b, 32b1, 32b2, 32c, 32c1, 32c2, 32d, 32d1, 32d2 having a positioning jaw contact surface 34 for contacting an edge of the cell stack 12 to be formed to hold it in position.

In the embodiments shown, the positioning device 20 has at least one arrangement 36, 36a, 36a1, 36a2, 36b, 36b1, 36b2, 36c, 36d comprising (at least) one vibrating jaw 26, 26a, 26a1, 26a2 on each of the—in this case—four sides a, b, c, d of the receptacle 18, 26b, 26b1, 26b2, 26c, 26d and (at least) one positioning jaw 32, 32a, 32a1, 32a2, 32b, 32b1, 32b2, 32c, 32c1, 32c2, 32d, 32d1, 32d2, such that at least two such arrangements 36, 36a, 36a1, 36a2, 36b, 36b1, 36b2, 36c, 36d face each other.

The vibrating jaws 26, 26a, 26a1, 26a2, 26b, 26b1, 26b2, 26c, 26d and vibration generators 24 for vibrating the vibrating jaws 26, 26a, 26a1, 26a2, 26b, 26b1, 26b2, 26c, 26d are provided on at least one vibration unit 38, 38a, 38a1, 38a2, 38b, 38b1, 38b2, 38c, 38d of the positioning device 20.

In preferred embodiments of the positioning device 20, the positioning jaws 32, 32a, 32a1, 32a2, 32b, 32b1, 32b2, 32c, 32c1, 32c2, 32d, 32d1, 32d2 and the vibrating jaws 26, 26a, 26a1, 26a2, 26b, 26b1, 26b2, 26c, 26d have, on a jaw area 40 forming the contact surfaces 28, 34, a complementary protrusion-recess feature 42 by which the positioning jaw 32, 32a, 32a1, 32a2, 32b, 32b1, 32b2, 32c, 32c1, 32c2, 32d, 32d1, 32d2 and the vibrating jaws 26, 26a, 26a1, 26a2, 26b, 26b1, 26b2, 26c, 26d engage.

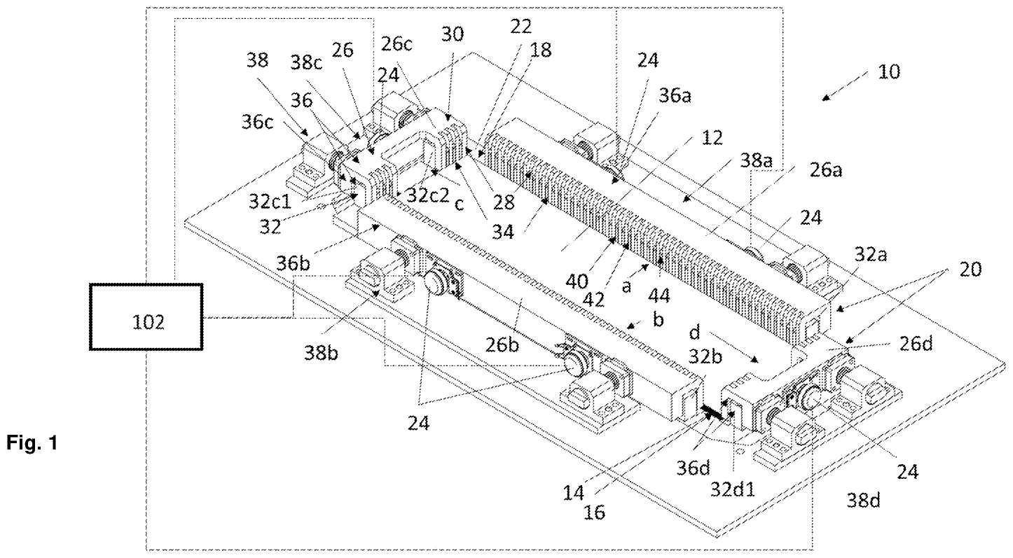

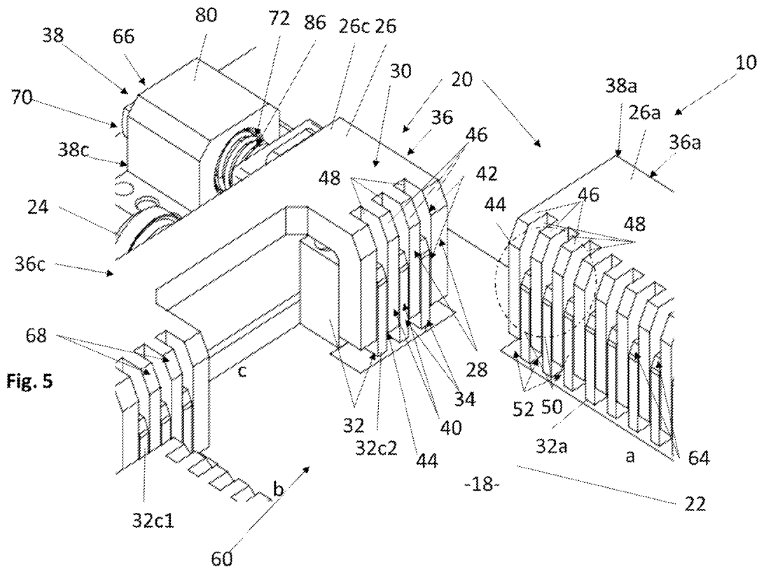

In a first embodiment shown in FIGS. 1 to 9d, the protrusion-recess feature 42 is formed as a comb structure 44 with teeth 46, 50 and grooves 48, 52 therebetween. Here, the vibrating jaws 26, 26a, 26b, 26c, 26d are movable linearly, substantially parallel to the main extension plane of the repeating components 14, 16 placed on the cell stack 12.

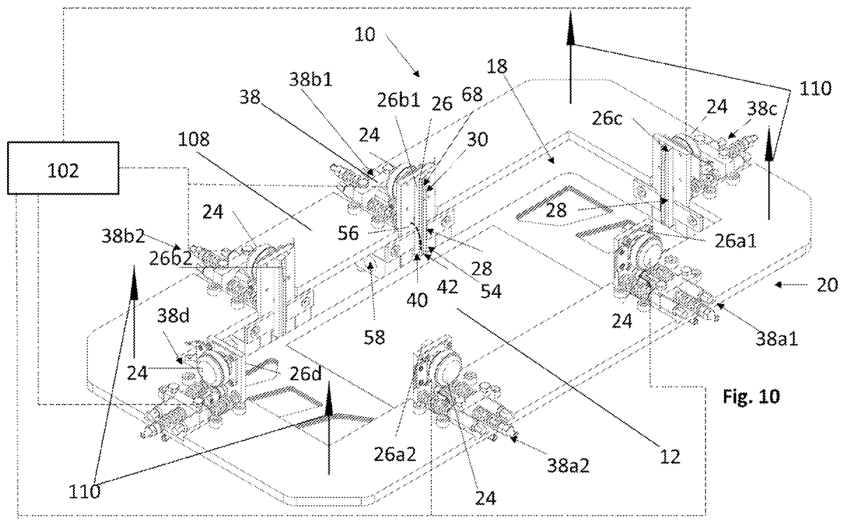

In a second embodiment shown in FIGS. 10 to 19, the at least one vibrating jaw 26, 26a1, 26a2, 26b1, 26b2, 26c, 26d is configured to move an end region 54 of the vibrating jaw contact surface 28 disposed near the positioning jaw contact surface 34 along an arcuate path 56 during oscillation, wherein a tangent of the arcuate path 56 lies on the positioning jaw contact surface 34. The arcuate path 56 may be ellipsoidal or parabolic, for example, by means of biaxial guidance or curved path guidance. Preferably, the arcuate path 56 is circular, wherein for this purpose the vibrating jaw 26, 26a1, 26a2, 26b1, 26b2, 26c, 26d rotationally moves about an axis 58 extending substantially parallel to the main extension plane of the repeating components placed on the cell stack 12.

The second embodiment may also have the complementary protrusion-recess features 42 on its arrangements 36, 36a1, 36a2, 36b1, 36b2, 36c, 36d of jogging jaw 26, 26a1, 26a2, 26b1, 26b2, 26c, 26d and positioning jaw 32, 32a1, 32a2, 32b1, 32b2, 32c, 32d, but this is not mandatory.

In the following, the stacking device 10 and the positioning device 20 according to the first embodiment will be explained in more detail with reference to the illustration in FIGS. 1 to 9d. In particular, positioning device 20 of the second embodiment is designed as a linear variant with linearly movable vibrating jaws 26, 26a-26d.

The receptacle 18 has a stacking table 60 as a supporting device 22, on which the cell stack 12 is deposited by depositing the repeating components on top of each other. Around the stacking table 60, first to fourth arrangements 36a-36d of at least one positioning jaw 32, 32a, 32b, 32c1, 32c2, 32d1, 32d2 and one vibrating jaw 26, 26a-26d are provided here in pairs opposite each other.

The positioning device 20 has a base plate 62 which is arranged here in a frame-like manner around the stacking table 60. The first to fourth vibration units 38, 38a-38d are mounted on the base plate 62.

The positioning jaws 32, 32a, 32b, 32c1, 32c2, 32d1, 32d2 of the first through fourth arrangements 36a-36d are stationarily mounted on the stacking table 60.

Thus, the stacking device 10 has, as main assemblies, the base plate 62 and the receptacle 18 with a stationary positioning unit formed by the positioning jaws 32, 32a, 32b, 32c1, 32c2, 32d1, 32d2, and a plurality of vibration units 38, 38a-38d.

The base plate 62 is used to receive the vibration units 38, 38a-38d and to support them, taking into account all adjustment possibilities. The base plate 62 is geometrically adapted to the receptacle 18. The receptacle 18 with the positioning jaws 32, 32a, 32b, 32c1, 32c2, 32d1, 32d2 dives through the base plate 62 from below.

In the receptacle 18 provided with the stacking table 60 and the stationary positioning jaws 32, 32a, 32b, 32c1, 32c2, 32d1, 32d2, the stacking of the repeating component/s 14, 16 into a cell stack 12 takes place. In this regard, the receptacle 18 may be positioned differently in vertical alignment with respect to the base plate 62. Using a Z-axis (not shown in the first embodiment) with actuators for positioning the receptacle 18, it is now possible to maintain the dropping height or insertion height for all repeating components 14, 16. For this purpose, the Z-axis clocks down by the corresponding material thickness after depositing or inserting a repeating component 14, 16.

Furthermore, this allows the stacking of cell stacks of different heights without having to adjust the vibration units 38, 38a-38d.

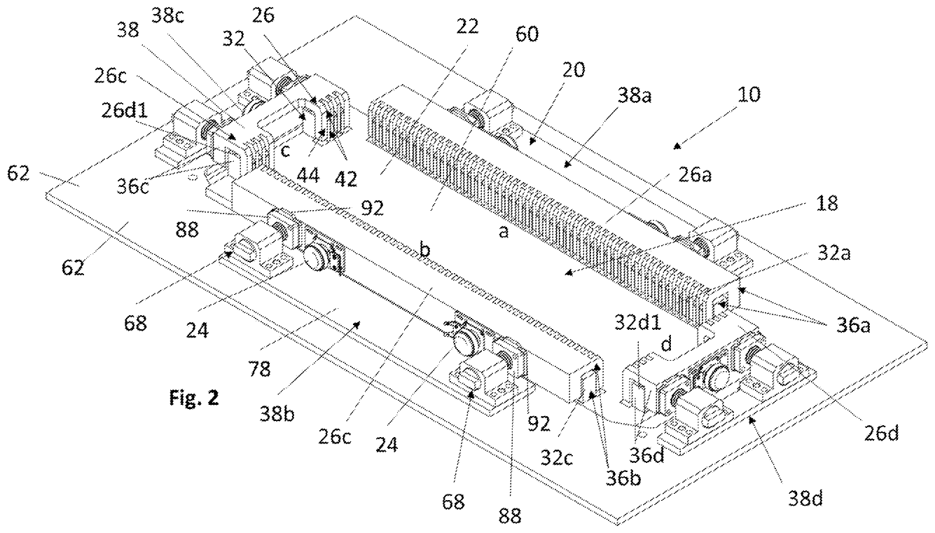

FIG. 1 shows the stacking device 10 with the positioning device 20 formed by positioning jaws 32, 32a, 32b, 32c1, 32c2, 32d1, 32d2 and the vibration units 38, 38a-38d with vibrating jaws 26, 26a-26d and the cell stack 12. FIG. 2 shows the basic layout of the stacking device 10 without the cell stack with the receptacle 18 in the uppermost end position.

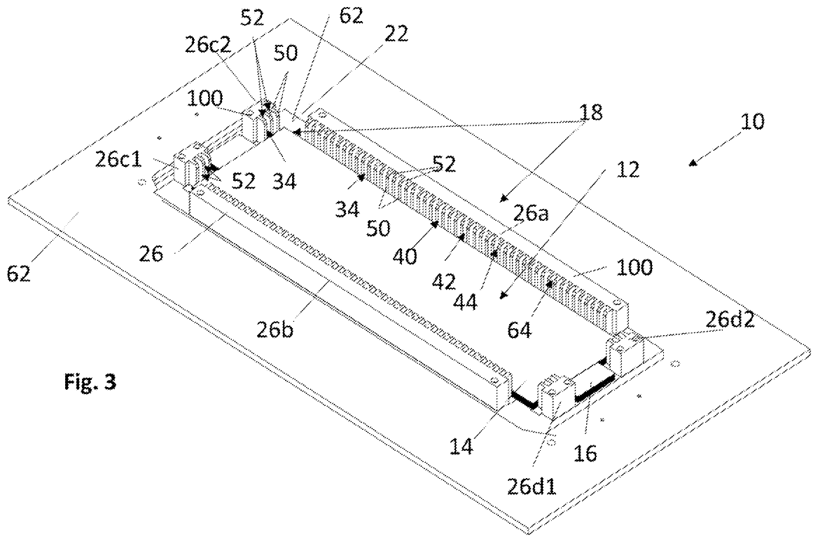

As mentioned above and shown in FIGS. 2 and 3, the receptacle 18 has the stacking table 60 to which the plurality of positioning jaws 32, 32a, 32b, 32c1, 32c2, 32d1, 32d2 are attached. The positioning jaws 32, 32a, 32b, 32c1, 32c2, 32d1, 32d2 are thus fixedly arranged on the stacking table 60 at the periphery of the repeating component/s 14, 16 and can be arranged over the complete length of one side—see the positioning jaw 32a, 32b of the first and second arrangements 36a, 36b—or only over a partial area of a side c, d—see the positioning jaws 28c1, 28c2, 28d1, 28d2 of the third and fourth arrangements 36c, 36d—so that the stack formation of a cell stack 12 takes place within the positioning jaws 32, 32a, 32b, 32c1, 32c2, 32d1, 32d2. It is also possible to arrange several positioning jaws 28c1, 28c2, 28d1, 28d2 on one side.

The positioning jaws 32, 32a, 32b, 32c1, 32c2, 32d1, 32d2 are used to pick up a cell stack 12 and bring it into position and hold it in position. For trouble-free and wear-free insertion of the repeating component/s 14, 16 by dropping or inserting, the positioning jaws 32, 32a, 32b, 32c1, 32c2, 32d1, 32d2 are designed with an insertion chamfer—shown here as an insertion slope 64 that can also be rounded—in the upper region.

The vibration units 38, 38a-38d as the upper part of the stacking device 10 and the positioning device 20, like the positioning jaws 32, 32a, 32b, 32c1, 32c2, 32d1, 32d2, are fixedly arranged on the base plate 62 at the periphery of the repeating component 14, 16 in such a way that the stacking of a cell stack 12 takes place within the vibration units 38, 38a-38d (see FIG. 1).

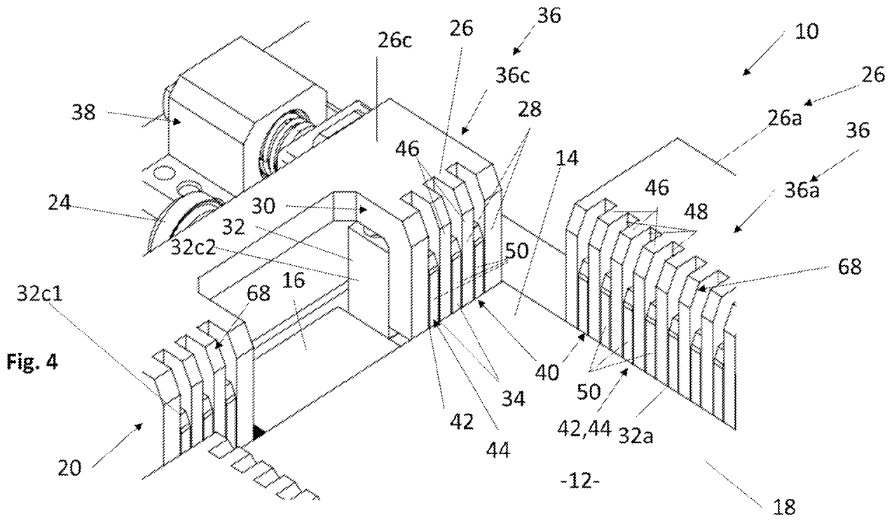

The structure and operation of the vibration units 38, 38a-38d will be described below with reference to FIGS. 4 to 7, using a vibration unit 38, 38c as an example.

For alignment of the repeating component 14, 16 during insertion between two oppositely arranged vibration units 38c, 38d, the vibrating jaw 26, 26c, 26d is vibrated by the vibration generator 24. The vibration oscillations are thereby directed via a linear bearing unit 66 such that the movement of the vibrating jaw 26, 26c, 26d occurs in a horizontal plane orthogonal to the edge of the repeating component 14, 16. Each vibration unit 38, 38a-38d is thereby fixedly attached to the base plate 62 of the stacking device 10 via one or more linear bearing unit(s) 66.

Suitable vibration generators 24 include vibration motors or structure-borne sound transducers.

For trouble-free and wear-free insertion of the repeating component/s 14, 16 by depositing or inserting them, the vibrating jaws 26, 26c are designed in the upper region with an insertion chamfer—rounded or beveled edge 64.

As can be seen, in particular, from FIGS. 1, 2 and 6, the vibration unit 38, 38a-38d of each of the arrangements 36, 36a-36d in the embodiment shown has at least two bearings 70 arranged at a distance from one another for linearly movably mounting the associated vibrating jaw 26, 26a-26d, and at least one preloading element 72 for preloading the vibrating jaw 26, 26a-26d against a first end stop 74. In the rest position thus provided, the vibrating jaw 26, 26a-26d is arranged furthest towards the center of the receptacle 18. Further, an adjustable second end stop 76 is provided for limiting the movement of the vibrating jaw 26, 26a-26d.

Thus, the vibrating jaw 26, 26a-26d is movably mounted between two end positions on the bearing 70, which comprises the preloading element 72 and at least one preferably adjustable stop 74, 76.

In particular, the vibrating jaw 26, 26a-26d is configured to oscillate between a first end position delimited by the first end stop 74, in which the vibrating jaw contact surface 28 and the positioning jaw contact surface 34 are aligned with respect to each other—i.e., in particular, are flush with each other—and a second end position delimited by the second end stop 76, in which the vibrating jaw contact surface 28 is at least regionally further away from the receptacle 18 for the cell stack 12 than the positioning jaw contact surface 34.

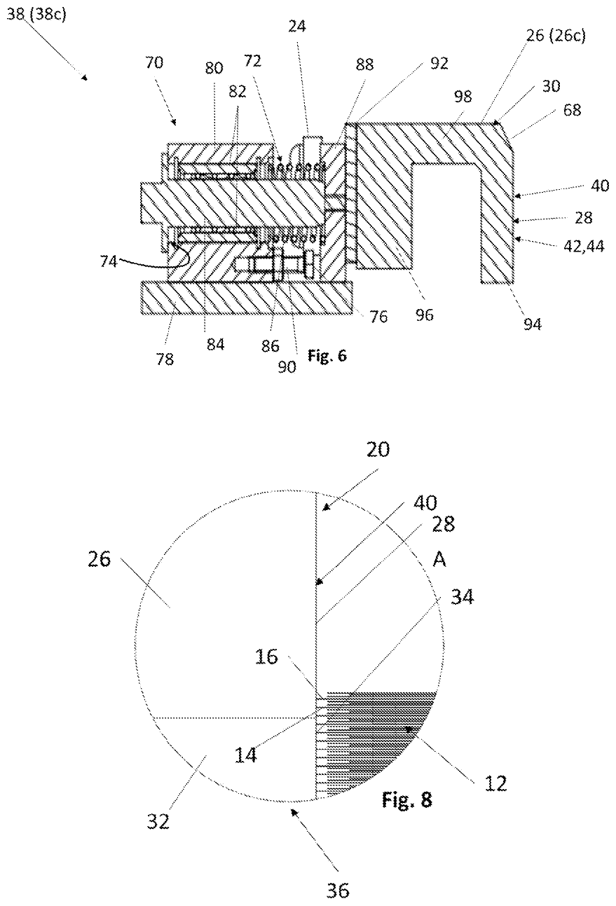

As can best be seen from FIG. 6, for this purpose the vibration unit 38, 38c in the specific embodiment shown has a base plate 78 for fastening on the base plate 62, a housing 80 for each of the at least two bearings 70, a linear guide means 82 received in the housing 80, a respective shaft 84 linearly guided therein, on which in the embodiment shown here the first end stop 74 is formed, for example as an integral flange or protrusion or as a separate element or the like, a respective spring 86, for example a helical compression spring arranged around the shaft 84, as a preloading element 72, a vibrating plate 88, which is attached to the shafts 84 of the spaced bearings 70 and thus oscillates and to which the vibrating jaw 26, 26c and the vibration generator 24 are attached, the second end stop 76, which is adjustable on the respective housing 80, for example by means of an adjusting screw 90, against which the vibrating plate 88 strikes, and a tuning plate 92, which is selected from an assortment of different tuning plates with different thicknesses and/or masses for adjusting the position of the vibrating jaw 26, 26c on the vibrating plate 88 and/or natural frequencies.

In the illustrated embodiment, the vibrating jaw 26, 26c is U-shaped in cross-section with a first leg 94 on which the vibrating jaw contact surface 28 and the protrusion-recess feature 42 are formed, and a second leg 96 which is connected to the shaft 84 and thus to the bearing 70 via the tuning plate 92 and the vibrating plate 88 and to which at least one of the vibration generators 24 is connected, and a web 98 which overlaps a body 100 of the associated positioning jaw 32, 32c1, 32c2. At the upper corner region between the first leg 94 and the web 98, the vibrating jaw 26, 26c is provided with the rounded or beveled edge 68 for forming the insertion phase for the repeating component 14, 16.

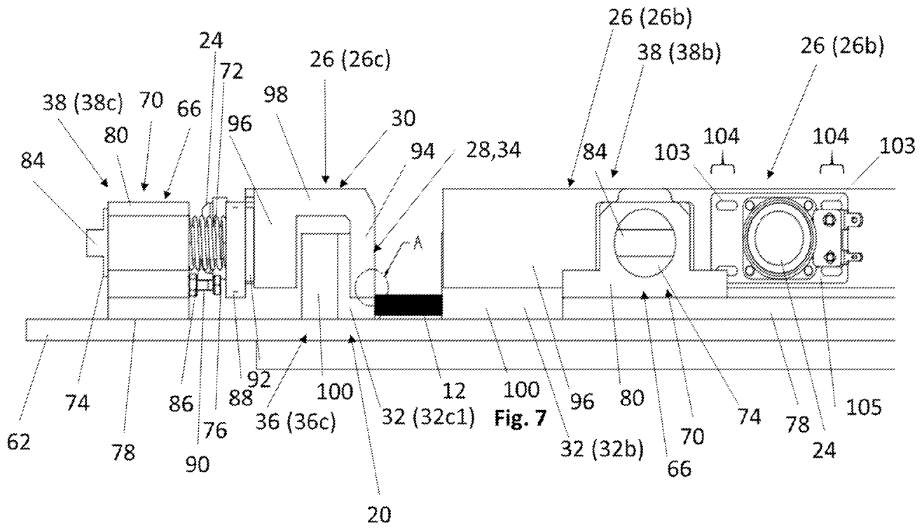

Various connection points 104 are provided on the second leg 94 for selective arrangement of the at least one vibration generator 24 or a plurality of vibration generators 24, so that natural frequencies can also be adjusted by this means. In FIG. 7, the adjustment of the connection point 104 is indicated by elongated holes 103 on a mounting plate 105 of the vibration generators 24. In the case of the longer vibration units 38a, 38b on the longer sides a, b, two vibration generators 24 each are provided in the setting shown here as an example, while in the setting shown here one vibration generator 24 each is provided on the shorter vibration units 38c, 38d.

According to FIGS. 1 and 6, the vibration units 38, 38a-38d thus each have one or more of the linear bearing unit/s 66 arranged on the base plate 78. A linear bearing unit 66 comprises the housing 80, in which the shaft 84 is mounted via the linear guide means 82. This shaft 84 is thereby geometrically designed in such a way that it is limited in its movement in a horizontal plane towards the cell stack 12, called forward in the following. This axial securing of the shaft 84 towards the front can be ensured by means of a shoulder or an additional component, for example a shaft circlip. Via the preloading element 72, such as the spring 86, it is ensured that the shaft 84 is urged forward in a horizontal plane against this first end stop 74. This spring 86, in turn, functions to allow movement of the vibrating plate 88 in the horizontal plane forward, toward the cell stack 12, or rearward, away from the cell stack 12. This movement is also accomplished by the vibrating jaw 26, 26a-26d, which is connected to the vibrating plate 88 via the tuning plate 92. The second end stop 76 allows the rearward movement (away from the cell stack 12) to be limited and adjusted.

The movement in this case is generated by the vibration generator 24, as described above.

By arranging single or multiple vibration generators 24 on a vibrating jaw 26, 26a-26d, for example via the long side a, b of the repeating component/s 14, 16, resp. via connection of the vibration generator 24 at different positions to the vibrating jaw 26, 26a-26d, the natural frequency of the vibrating jaw 26, 26a-26d and equally the dynamic behavior of the components can be adjusted, which is responsible for the correction of the position of the repeating component/s 14, 16 in the horizontal plane and, consequently, for the positional accuracy of the cell stack.

As indicated in FIG. 1, a controller 102 is further provided by means of which the individual vibration generators 24 of each arrangement 36, 36a-36d can be controlled individually and even differently.

In particular, when using one or more structure-borne sound transducer/s as vibration generator/s 24, the frequency of one/more vibration jaw/s 26, 26a-26d can thus be flexibly adjusted, this being of particular advantage when changing the format of the repeating component/s 14, 16. Even inactive operation of one or more vibration unit/s 38, 38a-38d is possible, so that one or more vibrating jaw/s 26, 26a-26d is/are used merely as an insertion aid. For this purpose, the vibrating jaw/s 26, 26a-26d is/are locked in the forward position by the preloading element 72, such as the spring 86.

Another advantage of the independent arrangement and control of the individual vibrating jaws 26, 26a-26d is that the opposing vibrating jaws 26a and 26b or 26c and 26d can be operated in the same direction, in opposite directions, or even offset (see FIG. 4). In this way, the required stacking and positioning accuracy can be influenced even more.

FIGS. 7 and 8 show that the position correction of one/more vibrating jaw/s 26, 26c only takes place for a small number of repeating components 14, 16, in the upper region of the cell stack 12. Active position correction of a larger number of repeating components 14, 16 or of all repeating components 14, 16 would not be expedient, since the static friction between the individual layers would be too great for position correction in the case of a larger cell stack 12.

As can be seen in particular from FIGS. 3 to 5 and FIGS. 9a-9d, the positioning jaw 32, 32a-32d2 with the body 72 is block-shaped or strip-shaped. Preferably, the positioning jaw 32, 32a-32d2 is chamfered or rounded at an upper end region above the positioning jaw contact surface 34 to form the insertion chamfer 64. Further, the positioning jaw 32, 32a-32d2 is formed such that protrusion-recess feature 42 is formed on a side surface facing the receptacle 18 for receiving the cell stack 12—the positioning jaw contact surface 34.

In order to enable the transfer of the repeating component/s 14, 16 from the vibrating unit 38, 38a-38d, in particular its vibrating jaw 26, 26a-26d, to one/more positioning jaw/s 32, 32a-32d2 under the premise of not losing the positioning accuracy of the repeating component/s 14, 16, the vibrating jaw/s 26, 26a-26d and the positioning jaw/s 32, 32a-32d2 is/are geometrically overlapped.

In this case, the vibrating jaw/s 26, 26a-26d can be geometrically designed in such a way that the alignment of the repeating component/s 14, 16 is only carried out in one or more partial areas.

For this purpose, the vibrating jaw 26 and the associated positioning jaw 32 are provided with the complementary protrusion-recess features 42.

As mentioned above and shown in particular in FIGS. 1 to 5, the protrusion-recess features 42 in the positioning jaw 32, 32a-32d2 and the vibrating jaw 26, 26a-26d of the first embodiment are formed respectively as a comb structure 44 with grooves 48, 52 formed between teeth 46, 50. Here, vibrating jaw teeth 46 engage positioning jaw grooves 52, and positioning jaw teeth 50 engage vibrating jaw grooves 48. Here, the comb structure 44 extends across the entire width of the contact surfaces 28, 34.

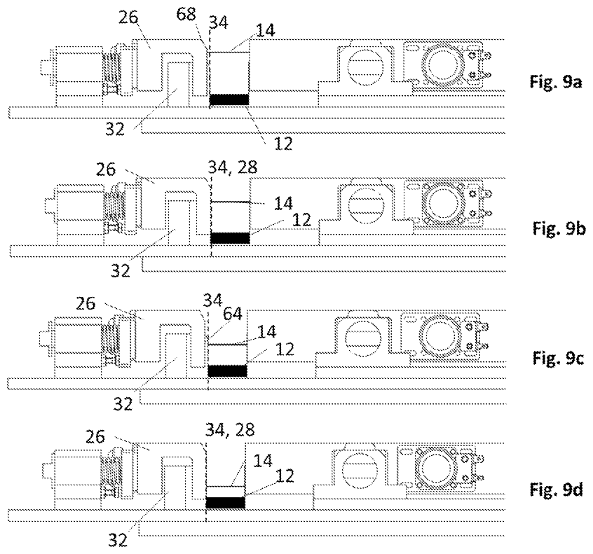

For better understanding, FIGS. 9a to 9d show a sequence of illustrations corresponding to the dropping or insertion of a repeating component 14, from the first coarse alignment of a repeating component 14 in the horizontal plane through the insertion phase—at the beveled edge 68—of a vibrating jaw 26, 26c in the rear position (see FIG. 9a), through the fine position correction by the stroke of the vibrating jaw 26, 26c to the forward position (see FIG. 9b), to the pick-up of one/more repeating component/s 14 by one/more positioning jaw/s 32, 32c1, 32c2 by the further lowering movement of one or more repeating component/s 14 (see FIGS. 9c and 9d).

In the following, with reference to FIGS. 10 to 19, the structure and operation of the stacking device 10 according to the second embodiment will be explained in more detail. In particular, the differences from the first embodiment will be discussed. Identical or corresponding parts are provided here with the same reference signs. In particular, the stacking device 10 also has the positioning device 20 which is arranged around the receptacle and which has the arrangements 36, 36a1, 36a2, 36b1, 36b2, 36c, 36d, which are formed by vibrating jaws 26, 26a1, 26a2, 26b1, 26b2, 26c, 26d that can be set in vibration under individual control by means of vibration generators 24 and positioning jaws 32, 32a1, 32a2, 32b1, 32b2, 32c, 32d that are stationary in operation. The vibration units 38, 38a1, 38a2, 38b1, 38b2, 38c, 38d, on which the vibrating jaws 26, 26a1, 26a2, 26b1, 26b2, 26c, 26d are formed, are here structurally different, so that the vibrating jaws 26, 26a1, 26a2, 26b1, 26b2, 26c, 26d move in an oscillating manner along the arcuate path 56, here designed as a circular path.

Further, in the second embodiment, the receptacle 18 is provided with a movable lateral guide 106, as described and shown in detail in documents [3] and [4] to which reference is made for further details on the structure of the receptacle 18.

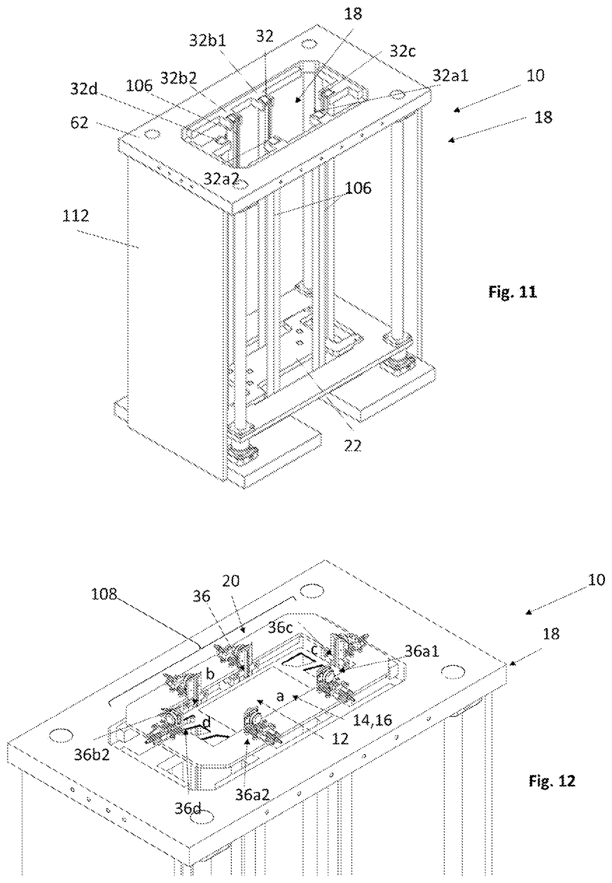

FIG. 10 shows the upper part of the stacking device 10 according to the second embodiment—also called rotatory variant due to the rotatory oscillatory movement of the vibrating jaws 26, 26a1, 26a2, 26b1, 26b2, 26c, 26d. FIG. 11 shows the lower part of the stacking device 10.

The upper part is formed as a vibration device 108. The vibration device 108 has the base plate 62, which is connected to a base frame 112 of the stacking device 10 via a lifting unit 110, which is not shown in detail. Vibration units 38, 38a1, 38a2, 38b1, 38b2, 38c, 38d are mounted on the base plate 62 and can be aligned to the specific characteristics of the repeating components 14, 16 to be processed.

The vibration device 108 shown in FIG. 10 is located directly above the receptacle 18 shown in FIG. 11, which receives the aligned repeating components 14, 16 as the stacking process progresses and stores them in position. The receptacle 18 has the base frame 112 with the guide means 106.

The combination of the vibration device 108 and the receptacle 18 is shown in FIG. 12.

Due to the mechanical properties of the repeating components 14, 16, only a very small number of superimposed components can be aligned without damage.

This number of repeating components, which are located within the vibration device 108 and are thus actively aligned by the vibration, can be adjusted by the lifting axis (Z-axis) of the height adjustment means. For this purpose, the Z-axis clocks with its actuators downwards by the corresponding material thickness after a repeating component has been placed or inserted, in order to keep the depositing position of the repeating components constant during the stacking process at the same time. The Z-axis actuators move the supporting device 22, on which the repeating components 14, 16 are placed, in the base frame 112 in the height direction.

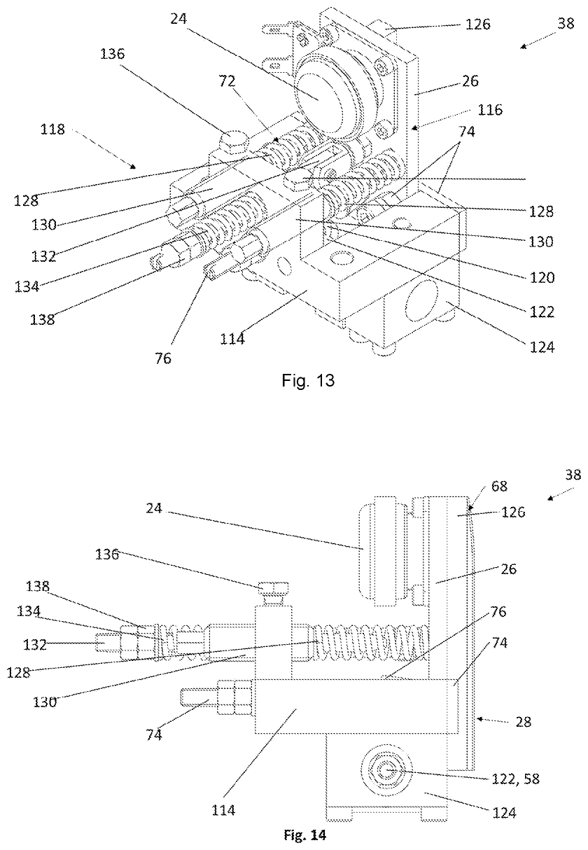

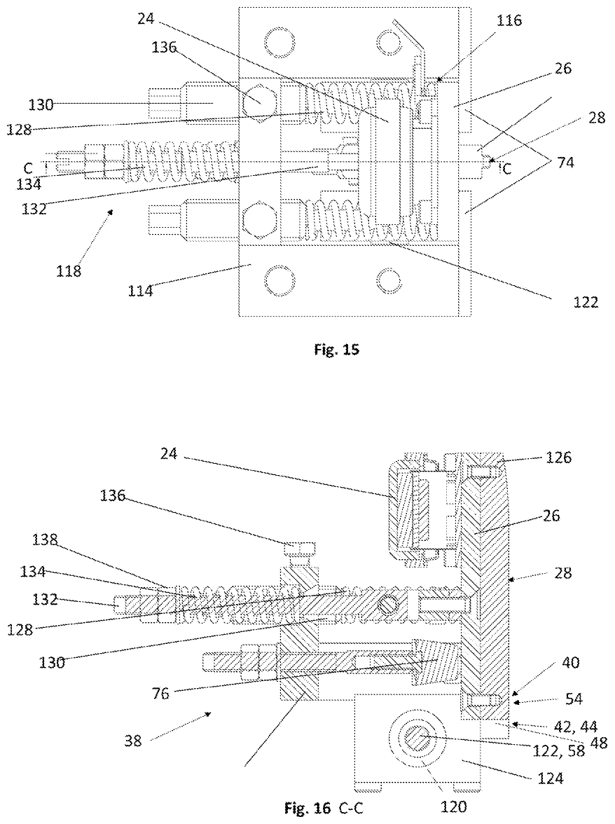

In the following, with reference to FIGS. 13 to 16, the structure of the vibration units 38, 38a1, 38a2, 38b1, 38b2, 38c, 38d of the same design is explained in more detail using one of the vibration units 38, 38c as an example. In this context, FIG. 13 shows a perspective view of the vibration unit 38, 38c, FIG. 14 a side view, FIG. 15 a top view, and FIG. 16 a section through the vibration unit 38, 38c along line C-C of FIG. 15.

The vibration unit 38, 38c comprises a base unit 114, an oscillator unit 116, and an adjustment unit 118.

The oscillator unit 116 comprises, as the actual oscillator, the vibrating jaw 26, 26c, which is rotatably connected to the base unit 114 via the bearing 70. Here, the bearing 70 comprises conventional roller bearings 120, a mounting shaft 122 and bearing blocks 124.

Mounted to the vibrating jaw 26, 26c, on the side facing away from the cell stack 12, is the vibration generator 24. On the side facing the cell stack 12, the vibrating jaw 26, 26c has an alignment strip 126 on which the vibrating jaw contact surface 28 is formed.

The vibrating jaw 26, 26c or its dynamic behavior can be adjusted to the respective application by the adjustment unit 118.

The adjustment unit 118 has at least one preloading element 72, here formed as a first compression spring 128, and at least one adjustable preloading unit 130 for adjusting the preloading force of the preloading element 72. In the specific embodiment, several, for example two, first compression springs 128 with a corresponding number of preloading units 130 are provided.

Further, the adjustment unit 118 comprises an adjustable coupling unit 132 for coupling to the vibrating jaw 26, 26c with adjustable relative position. In the illustrated embodiment, the coupling unit 132 is hingedly coupled to the vibrating jaw 26, 26c.

The adjustment unit 118 further comprises a further preloading element for acting in the opposite direction to the first preloading element 72. The further preloading element is formed here as a second compression spring 134.

The adjustment unit 118 comprises at least one locking element such as a locking screw 136 or a counter nut 138 for securing the adjustment of the at least one preloading unit 130 and/or the adjustable coupling unit 132.

Further, the adjustment unit 118 comprises the adjustable mechanical end stops 74, 76.

To adjust the dynamic behavior, the vibrating jaw 26, 26c is preloaded via the first two compression springs 128 by means of the preloading units 130 against the second compression spring 134 attached to the vibrating jaw 26, 26c by means of the adjustable coupling unit 132 according to the required dynamic characteristics for the best possible alignment of the repeating components 14, 16.

The preloading units 130 are secured against unintentional rotation by means of the locking screws 136. This ensures a constant preloading force of the first compression springs 128. Similarly, the coupling unit 132 is secured by counter nuts 138. This ensures a constant preloading force of the second compression spring 134.

The stiffness of the oscillation system can be fundamentally changed by replacing the preloading elements formed, for example, as compression springs 134, 128.

All adjustment elements 128, 130, 132, 134, 136, 138, which serve to regulate or adjust the dynamic behavior of the vibrating jaw 26, 26c acting as an oscillator, are attached and secured to the base unit 114.

The front as well as the rear mechanical end stop 74, 76 for limiting the oscillation amplitude are also connected to the base unit 114.

The contact between the vibration unit 38, 38c and the repeating components 14, 16 to be aligned takes place exclusively through the exchangeable alignment strip 126. This alignment strip 126 can thus be adapted to the required alignment geometry and adjusted with respect to the required mechanical properties.

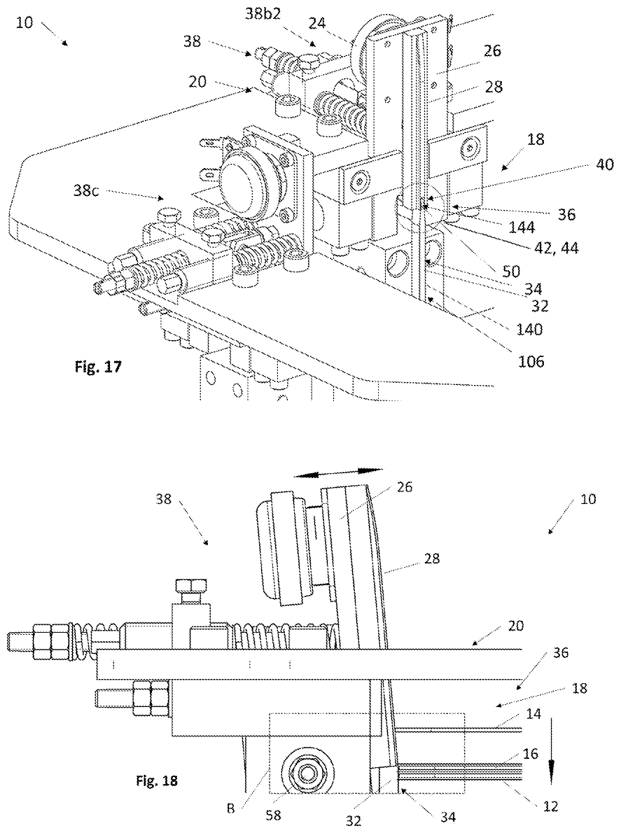

In the following, the structure and operation of the positioning device 20 with the interaction of the vibrating jaw 26 and the positioning jaw 32 are explained in more detail with reference to FIGS. 17 to 19.

FIG. 17 shows a perspective view of the arrangement 36, 36b1 formed by a vibration unit 38, 38b1 with the vibrating jaw 26, 26b1 and a positioning jaw 32, 32b1 arranged thereunder for explaining the structure of the positioning device 10 and for explaining the shape of the vibrating jaw 26, 26b1 provided for this purpose, specifically its vibrating jaw contact surface 28 formed here on the alignment strip 126.

The positioning jaws 32, 32a1-32d of the positioning device 10 of the second embodiment are formed in a strip-like manner and form the upper end of guide rails of the guide means 106.

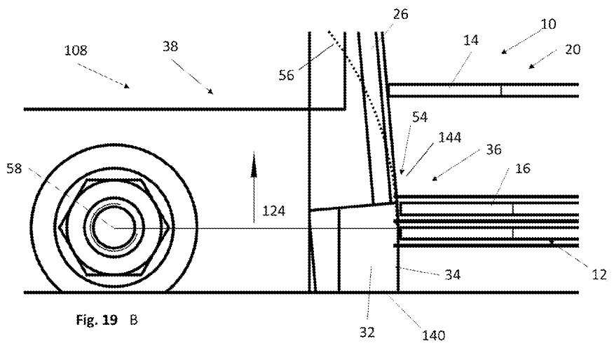

Since the transition between the active vibrating unit 38, 38b1 having the vibrating jaw 26, 26b1 and the rigid receptacle 18 having the rigid positioning jaw 32, 32a1 should be without offset to avoid jamming of the repeating components 14, 16, the positioning jaw contact surfaces 34 of the positioning jaws 32, 32a1-32d of the receptacle 18 are provided with an arcuate shape that corresponds exactly to the arcuate path 56 of the vibrating jaws 26, 26a1-26d. In the illustrated embodiment, in which the vibrating jaws 26, 26a1-26d rotate about the axis 58 defined by the mounting shaft rotating in the roller bearings 120, the positioning jaw contact surfaces 34 are provided with a rounding that corresponds exactly to the pivot radius 142 of the oscillator unit 116—see FIG. 19.

In addition, complementary protrusion-recess features 42 are provided on the contact surfaces 28, 34. In the illustrated embodiment, a comb structure 44 with only one tooth 50 is provided on one jaw, here on the positioning jaw 32, 32b1, which engages a groove 48 on the other jaw, here on the vibrating jaw 26, 26b1.

As a result, the alignment strip 126 and the alignment, i.e., the positioning jaw 32, 32b1 of the receptacle 18 engage with each other in a “comb-like” manner to also prevent canting/hooking (see FIG. 17).

In the following, with reference to the embodiment of FIGS. 18 and 19, an alignment process using the vibration units 38, 38a1-38d in the vibration device 108 will be briefly described, and some advantages thereof will be explained.

To begin with, it should be mentioned that due to the upstream processes with respect to material feeding/feeding of the repeating components (described in document [3] to which reference is made for further details), there is a free fall for both repeating components 14, 16 before they hit the height adjustment means in the stacking position. Due to this undefined depositing process, the repeating components should now be aligned until the required position tolerances are reached. Because of the changing mechanical properties of the repeating components 14, 16, it is proposed in this case that this alignment process is supported by vibration.

The starting point of the functional consideration is a repeating component 14 which is in a downward motion either by a horizontal throw or a vertical free fall with an initial velocity.

This repeating component 14 then hits the alignment strip 126 of a vibration unit 38, 38c during the insertion and undergoes an alignment towards the center of the receptacle 18 of the stacking device 10 due to the pivoting movement of the vibrating jaw 26, 26c. An alignment of the repeating components 14 would already be given even without active vibration as a result of the funnel-shaped structure of the oscillator unit 116 (see FIG. 18—this is an advantage of the rotary variant). In particular, the repeating component introduced by means of the horizontal throw is slowed down by the alignment strip 126, which greatly reduces the horizontal share of the movement and creates a rebound effect.

Due to the gradually decreasing movement space of the repeating components 14 in the vibration device 108 during the dropping process, the influence of the vibration/elongation on the resulting envelope or the position tolerances of the repeating components 14 increases Immediately before the repeating component 14 hits the underlying layer, the effect is at a maximum and thus also enables repeating components 14, which may already be slightly adherent and not sufficiently precisely positioned, to be detached again from the underlying layer and placed in an accurate position within the required tolerances.

At the transition of the perpendicular alignment strip 126 to the rigid alignment of the receptacle 18 formed by the positioning jaw 32, 32c, the existing movement space of the repeating component 14 corresponds to the permissible envelope of the overall stack. If the repeating component is within the alignment—guide means 106—of the receptacle 18 of the stacking device 10 from that point on and does not exhibit any damage in whatever form, it is considered to be aligned.

In FIG. 19, the tangential transition of the vibrating jaw contact surface 28 to the positioning jaw contact surface 34 with respect to the arcuate path 56 is indicated at the reference sign 144.

The advantage of the rotatory approach is that the vibration amplitude automatically decreases as the depositing process progresses (repeating component 14 approaches the depositing position). Thus, a larger positional tolerance can be covered in the upper region of the vibrating device 108, which is then progressively reduced during the free fall of the repeating component 14 until the defined envelope of the receptacle 18 of the stacking device 10 is reached.

In addition, the geometry of the rigid positioning jaws 32, 32a1-32d of the above-mentioned positioning device 20, which is adapted to the swivel radius 142 of the vibrating jaw 26, 26a1-26d, can prevent canting/jamming of the repeating components 14, 16 in the transition region between the receptacle 18 and the vibration device 108. There is always a “tangential” transition between the alignment strip 126 and the alignment of the receptacle (see FIG. 19)

The alignment height, in other words the guide length at which component alignment by vibration occurs, can be adapted by adjusting the vibrating jaw 26, 26a1-26d and modifying the alignment strip 126 accordingly.

The system can also be used passively, as a rigid system in the form of a conventional feed hopper, without replacement of components. In this case, the vibrating jaw 26, 26a1-26d is merely urged against the front mechanical end stop 74 by the preloading elements 72—first compression springs 128 in combination with the preloading units 130. Analogously, this locking can also be adopted by the rear mechanical end stop 76.

If the impact energy of the component inserted by means of horizontal throw exceeds the permissible value for the alignment range, the oscillator unit 116 can also be converted into a damper system by appropriate selection of compression springs 128, 134 or other preloading elements, in order to absorb the kinetic energy of the repeating component 14 and preventing damage.

The construction of the vibration device 108 from individual, independent vibration units 38, 38a1-38d also results in the possibility of generating specific frequencies and amplitudes, allowing a flexible response to workpiece requirements.

Control of the vibration generators 24 may be accomplished as described above for the first embodiment.

Combinations of the various features of the embodiment described herein are of course possible.

Preferred embodiments of the invention relate to a system for receiving, positioning and fixing all components required for the assembly or manufacture of battery cells, such as lithium-ion battery cells, or fuel cell stacks, such as PEMFC stacks, with a view to manufacturing in a large-scale production facility. Positioning devices 20, stacking devices 10, and stacking methods according to embodiments of the invention are used in the following overall processes I and II for manufacturing battery cells or fuel cells:

I. Description of the Overall Process (Battery Cell):

The production process of a lithium-ion battery cell includes the four main process steps of electrode fabrication, cell assembly, and cell forming and aging.

Regardless of different cell types (cylindrical cell, prismatic cell or pouch cell), the smallest unit of each lithium-ion cell consists of two electrodes, anode A (e.g. copper graphite coated) and cathode K (e.g. ALU NMC-111 coated), and a separator S that separates the electrodes. In preferred processes, the cathode K is approx. 1 mm smaller all around than the anode A. The separator S is the largest part of a cell and is circumferentially approx. 1 mm larger than the anode A.

To manufacture a cell, a stacking process is carried out in which the individual electrodes A, K including separator S are stacked in several layers until a desired cell capacity is achieved. In this process step, exact positioning of the electrodes is required to ensure high electrical conductivity and thus high power density. In order to be able to maintain the exact position of the individual layers, these components are bonded or laminated together in different sequences SASK or SKSA. This unit, consisting of four layers, represents a monocell.

The electrodes A, K and the separator S are examples of repeating components of a cell stack of a battery cell. In other types of battery cells, other repeating components may also be present.

In order to produce a complete cell stack from many individual layers or laminated or glued cell stacks, the repeating component/s monocell/s is or are positioned/stacked on top of each other. For this purpose, the repeating component/s is or are usually automatically set to a position via a handling system and, if necessary, checked by means of image processing. Applications with vacuum grippers or vacuum technology are often used for handling the repeating component/s monocell, as well as workpiece carriers with integrated hold-down devices that fix the repeating component/s monocells in position after placement.

II. Description of the Overall Process (Fuel Cell):

Some embodiments of the invention relate to a stacking device 10 for manufacturing a fuel cell assembly, such as a PEMFC stack. A stacking device 10 for the manufacturing process of the PEMFC stack is a stacking device 10 that receives alternately inserted repeating components BPP and MEA, aligns them and guides them for the further downstream processes in a stationary manner, within the predetermined position tolerance. Some further details of preferred embodiments of the stacking device are already described and shown in the unpublished documents [3] and [4], which are hereby incorporated by reference.

In preferred embodiments, MEA components are to be alternately inserted laterally and BPP components are to be inserted vertically from above through a feed system into the stacking device 10 to build the stack. An alignment, especially of the MEA components due to the lateral insertion and the associated change of the direction of movement from horizontal to vertical, is preferably performed by a guide system of the stacking device. Due to the exclusively vertical depositing movement of the BPP, only very little effort is required for alignment/positioning compared to the MEA. The total cycle time for depositing a single cell consisting of BPP and MEA can thus be proportionally distributed to the respective component by the design of the individual systems. Depending on requirements, it is thus possible, for example, to proportionally allocate more cycle time to the depositing of the MEA if this process requires more time. If necessary, the depositing process can be additionally supported in the depositing area, optionally by vibration, which simplifies the alignment of the most recently deposited components.

Devices and methods have thus been described that are to be used in large-scale production of battery cells or fuel cells when forming cell stacks (12). To improve process reliability at high process speeds and low tolerances, a positioning device (20) for positioning the repeating components (14, 16) of the cell stack (12) has been proposed. The positioning device (20) comprises at least one vibrating jaw (26, 26a, 26a1, 26a2, 26b, 26b1, 26b2, 26c, 26d) having a vibrating jaw contact surface (28), and a positioning jaw (32, 32a1, 32a2, 32b1, 32b2, 32c, 32d) which has a positioning jaw contact surface (34) and which is rigid in operation and is arranged lower than an upper region (30) of the vibrating jaw (26, 26a1, 26a2, 26b, 26b1, 26b2, 26c, 26d). In one embodiment of the positioning device (20), the jaws engage each other with complementary protrusion-recess features (42) at the contact surfaces (28, 34). Alternatively or additionally, the vibrating jaw (26, 26a, 26a1, 26a2, 26b, 26b1, 26b2, 26c, 26d) is provided to move along an arcuate path (56) during oscillation, a tangent of the arcuate path (56) lying on the positioning jaw abutment surface (34).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 stacking device
12 cell stack
14 first repeating component
16 second repeating component
18 receptacle for the cell stack
20 positioning device
22 supporting device
24 vibration generator
26 vibrating jaw
26a first vibrating jaw
26a1 first vibrating jaw
26a2 first vibrating jaw
26b second vibrating jaw
26b1 second vibrating jaw
26b2 second vibrating jaw
26c third vibrating jaw
26d fourth vibrating jaw
28 vibrating jaw contact surface
30 upper region of the vibrating jaw
32 positioning jaw
32a first positioning jaw
32a1 first positioning jaw
32a2 first positioning jaw
32b second positioning jaw
32b1 second positioning jaw
32b2 second positioning jaw
32c third positioning jaw
32c1 third positioning jaw
32c2 third positioning jaw
32 fourth positioning jaw
32d1 fourth positioning jaw
32d2 fourth positioning jaw
34 positioning jaw contact surface
36 arrangement of vibrating jaw and positioning jaw
36a first arrangement
36a1 first arrangement
36a2 first arrangement
36b second arrangement
36b1 second arrangement
36b2 second arrangement
36c third arrangement
36d fourth arrangement
38 vibration unit
38a first vibration unit
38a1 first vibration unit
38a2 first vibration unit
38b second vibration unit
38b1 second vibration unit
38b2 second vibration unit
38c third vibration unit
38d fourth vibration unit
40 jaw area
42 protrusion-recess feature
44 comb structure
46 vibrating jaw tooth
48 vibrating jaw groove
50 positioning jaw tooth
52 positioning jaw groove
54 end region of the vibrating jaw contact surface
56 curved path
58 axis
60 stacking table
62 base plate
64 insertion slope (positioning jaw)
66 linear bearing unit
68 rounded or beveled edge
70 bearing
72 preloading element
74 first end stop
76 second end stop
78 base plate
80 housing
82 linear guide means
84 shaft
86 spring
88 vibrating plate
90 adjusting screw
92 tuning plate
94 first leg
96 second leg
98 web
100 positioning jaw body
102 controller
103 oblong hole
104 connection point
105 mounting plate
106 guide means
108 vibration device
110 lifting unit
112 base unit
114 base unit
116 oscillator unit
118 adjustment unit
120 roller bearing
122 mounting shaft
124 bearing block
126 alignment strip
128 first compression spring
130 preloading unit
132 coupling unit
134 second compression spring
136 locking screw
138 counter nut
140 guide rail
142 swivel radius
144 tangential transition of vibration device alignment strip and alignment
of receptacle of stacking device
a first side (long side)
b second side (long side)
c third side (short side)
d fourth side (short side)

1. A positioning device for positioning repeating components of a cell stack for battery or fuel cells to be placed one on top of the other, comprising:
a vibrating jaw which can be set in vibration by means of at least one vibration generator and has a vibrating jaw contact surface for contacting an edge of the repeating component to be laid for vibrationally centering the same, and
a positioning jaw which is rigid in operation and is disposed below an upper region of the vibrating jaw and has a positioning jaw contact surface for contacting an edge of the cell stack to be formed for holding the same in position,
wherein at least one of
the positioning jaw and the vibrating jaw have, on a jaw area forming the contact surfaces, a complementary protrusion-recess feature by which the positioning jaw and the vibrating jaw engage with each other, or
the vibrating jaw is configured to move an end region of the vibrating jaw contact surface arranged near the positioning jaw contact surface along an arcuate path during oscillation, a tangent of the arcuate path lying on the positioning jaw contact surface.

2. The positioning device according to claim 1, wherein the protrusion-recess feature, at least one of:
is a comb structure with grooves formed between teeth, wherein vibrating jaw teeth engage positioning jaw grooves and positioning jaw teeth engage vibrating jaw grooves, wherein the contact surfaces are formed at least partially on the teeth, or
extends over an entire width of the contact surfaces.

3. The positioning device according to claim 1, wherein a first arrangement of a first positioning jaw and a first vibrating jaw, and a second arrangement of a second positioning jaw and a second vibrating jaw oppose each other on a first pair of opposite sides of a receptacle for the cell stack.

4. The positioning device according to claim 3, wherein a third arrangement of a third positioning jaw and a third vibrating jaw, and a fourth arrangement of a fourth positioning jaw and a fourth vibrating jaw oppose each other on a second pair of opposite sides of the receptacle for the cell stack.

5. The positioning device according to claim 3, further comprising at least one of the features:
that the vibration generators of different arrangements are at least one of individually or differently controllable,
that a controller is provided and configured to control the vibration generators such that
a movement of the vibration generators takes place in pairs in opposite directions or
the movement of the vibration generators takes place in pairs in the same direction, or
individual vibration generators are inactive.

6. The positioning device according to claim 1, wherein the vibrating jaw is U-shaped in cross-section with a first leg, on which the vibrating jaw contact surface and the protrusion-recess feature are formed, and a second leg connected to the vibration generator, and a web which overlaps a body of the positioning jaw.

7. The positioning device according to claim 1, wherein the positioning jaw, at least one of:
is chamfered or rounded at an upper end region above the positioning jaw contact surface to form an insertion slope,
is rounded at an upper end region of the positioning jaw contact surface correspondingly flush or aligned with the arcuate path,
is block-shaped or strip-shaped,
is formed in such a way that the protrusion-recess feature is formed on a side surface facing a receptacle for receiving the cell stack, or
extends along a height direction for guiding the edges of the repeating components in the cell stack during height tracking in the receptacle.

8. The positioning device according to claim 1, wherein the vibrating jaw, at least one of:
oscillates between a first end position in which the vibrating jaw contact surface and the positioning jaw contact surface are aligned with respect to one another, and a second end position in which the vibrating jaw contact surface is further away from a receptacle for the cell stack than the positioning jaw contact surface, at least in regions,
is supported on a bearing, which has a preloading element and at least one preferably adjustable end stop, such that the vibrating jaw can be moved between two end positions,
can be connected to the vibration generator or optionally to several vibration generators at selectively variable connection points to set natural frequencies, or
can be oscillated linearly back and forth perpendicular to the vibrating jaw contact surface, or
oscillates about an axis aligned horizontally and parallel to the vibrating jaw contact surface, or
turns back and forth about an axis aligned horizontally and parallel to the vibrating jaw contact surface during oscillation.

9. A stacking device for forming a cell stack for a battery cell or fuel cell from repeating components to be placed one on top of the other, comprising:
at least one positioning device according to claim 1, and
a receptacle with a supporting device movable in a height direction for supporting and adjusting a height of the cell stack during stacking.

10. A stacking method for forming a cell stack for a battery cell or fuel cell from a plurality of repeating components to be placed one on top of the other comprising
a) providing a stacking device according to claim 9,
b) depositing a repeating component,
c) centering the repeating component by vibrating the vibrating jaw to bring the vibrating jaw into contact with the positioning jaw contact surface,
e) repeating steps a) through c) with additional repeating components to form the cell stack.

11. The stacking method according to claim 10, further including as a step to be performed after step c):
(d) moving the supporting device downward,
wherein steps a) to d) are repeated with the additional repeating components in step e).
